(19) United States
(12) Patent Application Publication
(10) Pub. No.: US 2009/0057579 A1
(43) Pub. Date: Mar. 5, 2009

(54) SPINNING INFRARED EMITTER

(75) Inventor: Volodymyr Pylypchuk, Kiev (UA)

Correspondence Address: CONNOLLY BOVE LODGE & HUTZ LLP, 1875 EYE STREET, N.W., SUITE 1100, WASHINGTON, DC, 20006, US

(73) Assignee: Immunitor USA, College Park, MD (US)

(21) Appl. No.: 12/164,708

(22) Filed: Jun. 30, 2008

Related U.S. Application Data
(60) Provisional application No. 60/946,862, filed on Jun. 28, 2007.

(51) Int. Cl. G01J 3/10

(52) U.S. Cl. 250/504 R

(57) ABSTRACT

A spinning infrared emitter is disclosed which has a light source that in one aspect emits infrared and/or near-infrared light and a controller that spins the light. Also disclosed are methods of using the light produced by the spinning infrared emitter. The light produced by the spinning infrared emitter is generally useful for speeding chemical reactions. More particularly, the light produced by the spinning infrared emitter is useful for enhancing photosynthesis and carbon dioxide fixation by green plants.

The present disclosure relates to a light-emitting apparatus containing an infrared-emitting element and a controlling or rotating device which provides spinning movement or angular momentum to emitted light.

A light-emitting diode (LED) is a semiconductor device that emits incoherent narrow-spectrum light when electrically biased in the forward direction of the p-n junction. This effect is a form of electroluminescence. An LED is a small extended source with extra optics added to the chip that makes it emit a complex radiation pattern. The color of the emitted light depends on the composition and condition of the semiconducting material used, and can be visible, ultraviolet or infrared spectrum.

In the late 19th century, Henry Round of Marconi Labs first noted that semiconductor diodes could produce light. Oleg Vladimirovich Losev independently created the first LED in the mid 1920s. His research, though distributed in Russian, German and British scientific journals, was ignored. Rubin Braunstein of the Radio Corporation of America reported on infrared emission from gallium arsenide (GaAs) and other semiconductor alloys in 1955. Experimenters at Texas Instruments, Bob Biard and Gary Pittman, found in 1961 that gallium arsenide gave off infrared (invisible) light when electric current was applied. Biard and Pittman were able to establish the priority of their work and received a US patent; see for example U.S. Pat. No. 3,821,775, for the infrared light-emitting diode. Infrared LEDs continue to be used today as transmitters in fiber optic data communication systems. Other well-known examples of uses of LEDs are a remote control for TV sets or a garage door opener and other common household items.

Global warming has been linked to the growing amount of heat-trapping gases such as carbon dioxide in the atmosphere. If the warming continues catastrophic consequences may ensue. The global warming is likely to trigger a rise in sea levels and a greater frequency and severity of extreme weather events. Human activities that contribute to climate change include the burning of fossil fuels, agriculture and land-use changes like deforestation. These cause increase in emissions of carbon dioxide (CO₂), the main gas responsible for climate change. CO₂ is not a pollutant, but rather a building block of life on Earth. It is necessary for the growth of all green plants, and therefore, all life on the planet. Plants, including grains, need CO₂ to grow. The fact that plants emit oxygen (O₂) as a result is necessary to the animal life on Earth. However, in the last 200 years, there has been an increase in the amount of CO₂ in the atmosphere from about 250 PPM to 350 PPM. The increase since the late 1950s has even been remarkable. The increased level results from the burning of fossil fuels and coincides with the advent of the Industrial Revolution. In recent years the level appears to be increasing at the rate of 1 PPM per year. The scientific community is in general agreement that, to the extent that global warming occurs, the level of CO₂ in the atmosphere will be a major contributing factor. As greenhouse gas emissions, such as CO₂, continue to rise, there is an urgent need to solve this problem, i.e., remove CO₂ from the atmosphere.

Visible light is one small part of the electromagnetic spectrum. The longer the wavelength of visible light, the more red is the color. Likewise the shorter wavelengths are towards the violet side of the spectrum. Wavelengths shorter than violet are ultraviolet and those longer than red are referred to as infrared. Visible light is between 400 to 700 nm, and the infrared light ranges from 700 to 300,000 nm. The spectrum of infrared closest to visible light is called near infrared (NIR), which usually ranges from 700 to 1,100 nm.

The major global source of infrared is the sun. At the surface of Earth, we receive only part of the solar radiation because the atmosphere acts like a filter. Most of the light in the visible spectrum passes through our atmosphere unabsorbed, but the shorter (ultraviolet and X-ray) and longer (infrared) wavelengths are selectively absorbed by the atmosphere. It is recognized that ultraviolet is absorbed by ozone and infrared by carbon dioxide and water vapor. At the longest infrared wavelengths the Earth's atmosphere is somewhat more transparent and this spectrum is largely responsible for keeping the Earth warm.

Photosynthesis in all higher plants is dependent on ultraviolet irradiation in addition to visible light. The ultraviolet, including UVA-, UVB-, and UVC-light, at high intensity is damaging to photosynthesis, see for example U.S. Pat. No. 5,929,455. The prior art taught that the photosynthesis requires ultra violet and visible light, see for example U.S. Pat. No. 4,291,674.

Surprisingly, this invention indicates that infrared spectrum is also important for photosynthesis.

However, there is an increasing shortage of NIR as the Earth's atmosphere is more and more overloaded with emission gasses. Terrestrial plants and phytoplankton in the oceans are the main regulators of global CO₂ balance on the Earth. Carbon dioxide is the major greenhouse gas that contributes to global warming. According to the EPA a typical car gives off 10 kg of CO₂ for every gallon of gas consumed. An average tree absorbs approximately 10 kg of CO₂ per year. However, for optimal photosynthesis, plants require NIR light that is not readily available. The instant disclosure allows delivery of infrared in the part of the spectrum that is increasingly scarce and thus has an enormous potential to reduce emission of CO₂. However, radiating infrared over large areas is costly. Surprisingly adding rotating moment or torque to radiation appeared to enhance the coverage of radiation and its beneficial effect on photochemical reaction in plants or photosynthesis.

As a result, a simple technology is developed that allows NIR radiation to be delivered over large areas at low cost. The invention is applicable to situations where the generator of radiation is any kind of radiator that emits heat and hence infrared radiation. The invention equally applies to at least one predetermined band of the infrared spectrum. In one aspect, what is especially contemplated is to deliver near-infrared radiation. This particular portion of the infrared spectrum is becoming scarce due to the capture of the sun's NIR by an increasingly “opaque” atmosphere. Infrared stimulates plants' growth and photosynthesis. Photosynthesis is the conversion of solar energy into chemical reaction that consumes carbon dioxide and produces oxygen. The general formula is as follows: 6H₂O+6 CO₂→C₆H₁₂O₂+6O₂. The infrared emitter of the instant disclosure is capable of inducing plants to consume approximately 25% more CO₂ and transform it to oxygen.

There are several projects aimed at reducing carbon emission most of which are directed at simply trapping CO₂. For example U.S. Pat. No. 6,667,171 describes photosynthetic carbon sequestration by cyanobacteria in a containment chamber that is lit by solar photons. Other examples of representative projects in this area are found in http://the25milliondollaridea.blogspot.com/ for representative projects in this area and this website incorporated herein by way of reference.

While the value of such projects varies, the projects often require enormous initial capital and their ecological impact may negate the overall benefit. The present disclosure is more advantageous from both practical and ecological viewpoints. Changes in land use (primarily deforestation) currently constitute about 20% of global anthropogenic CO₂ emissions. Planting new forests may be a way of compensating for these emissions. But again, this undertaking requires heavy investment, is labor-intensive and not easily implemented. If one can enhance the photocatalytic activity of existing forests by at least 20% one can reverse anthropogenic output of CO₂ emissions without relying on planting forests. The cost would be several orders of magnitude smaller than any existing project.

The present disclosure allows delivery of low-cost infrared, preferably near infrared, radiation over large areas, thus accelerating the photosynthesis of plants and algae, which can result in capture of CO₂ in an ecologically friendly manner.

The disclosure has been devised in view of the above-described problems, and accordingly in one aspect provides a light-emitting apparatus that will emit light, preferably in the infrared spectrum. The infrared radiation of the type produced by the apparatus will accelerate a photosynthesis reaction resulting in enhanced consumption of carbon dioxide.

The disclosure provides a radiation or light-emitting apparatus comprising a light-emitting element and a controlling device that gives the emitted light a spinning pattern. The spinning pattern is provided electronically or mechanically. Providing spin by electronic means refers to art-known methods of giving emitted light a twist without actually rotating the light-emitting element. Providing spin by mechanical means refers to art-known methods of giving emitted light a twist by rotating the light-emitting element.

In one aspect, the speed of rotation is from about 100 to about 1000 rotations per second. In another aspect, the speed of rotation is from 200 to 500 rotations per second. In yet another aspect the preferred speed for rotating the emitted light or velocity of spinning momentum is at least about 240 rotations per second. The rotation speed can be about 240 rotations per second. Speed can be constant or variable depending on requirements and can be chosen as appropriate. In other aspects, lower angular velocity is also considered. In general, but not in all cases, the effects claimed by this invention appear to be smaller when the speed of rotation is lower, which may be unsatisfactory in certain but not all circumstances.

Another aspect of this disclosure is to accelerate the photosynthesis reaction by providing irradiation from a light-emitting apparatus as a source of energy at wavelengths that are preferably in the infrared and/or near infrared spectrum, at least in part.

Notwithstanding the preferred embodiment of the invention which is based on irradiating in the infrared and/or NIR spectrum, it is also advantageous to have an apparatus which would irradiate spinning light in other spectra including the visible and ultraviolet ranges of the electromagnetic spectrum. Without departing from the scope of instant disclosure, it did occur to the present inventor that other wavelengths may be advantageously modified by spinning the electromagnetic radiation, in terms of power and distances to be covered. In one aspect, these wavelengths can be below the ultraviolet spectrum such as gamma radiation or can be longer than infrared, such as microwaves and radiowaves. Thus any electromagnetic radiation, down to single photon level, is amenable by instant invention.

Using the instant disclosure one can easily imagine improved antennas or better imaging devices such as X-ray machines that will require less power but will have better or the same resolution or penetrating power.

Still another aspect of the disclosure is to reduce the levels of carbon dioxide by accelerating the photosynthesis reaction in plants or algae by providing infrared and/or NIR radiation. Within the limits of this application the emitter of the invention can be viewed as a photo-reactor or photo-accelerator.

Another aspect of the disclosure is to provide a method for reducing net carbon gas emissions to the atmosphere by irradiating large areas of plants or algae with the apparatus of the disclosure.

It is also an aspect of this disclosure to promote photosynthesis in plants, so as to accelerate growth, and advance harvests, so as to increase their market value and make these less dependent of the weather and natural or artificial light conditions. A more specific aspect of the disclosure is to provide light emitting diodes (LEDs), particularly as sources of infrared and/or NIR which promote photosynthesis. In a yet more specific aspect, the light from the infrared or NIR light is subjected to spinning.

One aspect of the disclosure may be briefly summarized as follows. It is known that the wavelength of the incident radiation directly determines the proportion of absorbed photon energy. This means that one can enhance a photochemical reaction by practically any electromagnetic irradiation as long as it is given the spinning momentum. The difference in wavelength will however dictate the efficiency of enhancement. This differential will be easily determined experimentally by those skilled in the art.

Other aspects, objects, features and advantages of the present disclosure will be more fully apparent from the accompanying drawings, the following detailed description, and the appended claims.

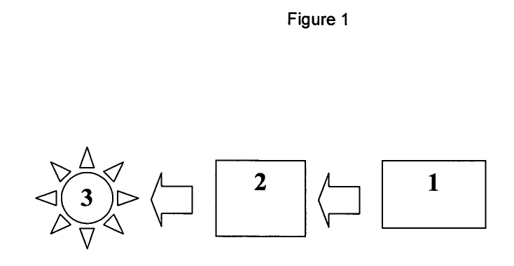

FIG. 1 is a schematic diagram of one aspect of the infrared radiation element of the present disclosure, including a power source either in DC or AC voltage (1), a light or radiation source such as a LED emitting NIR (2), and a rotating device (3), which spins emitted radiation either electronically or mechanically. When spin is electronically controlled it is preferable that the rotating device (3) is connected between power source (1) and radiation source (2). In a situation in which rotation is mechanically controlled, then the rotating device (3) spins the radiation source (2).

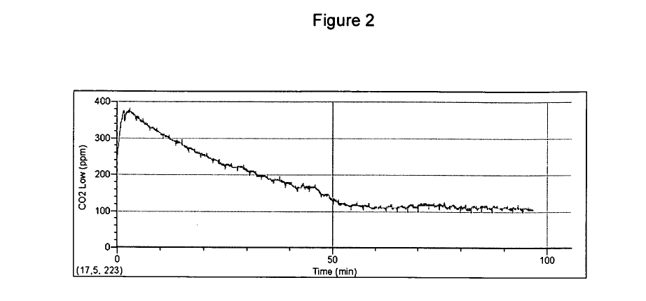

FIG. 2 shows a representative example of enhancement of photosynthesis reaction resulting in reduction in CO₂ levels when an infrared emitter is switched on at 45 minutes after starting the experiment. The enhancement in CO₂ uptake in this experiment is approximately 30% as compared to plateau level at which CO₂ stabilized prior to switching the infrared emitter (165 ppm vs 113 ppm). PPM stands for parts per million.

The term “light” refers to electromagnetic radiation in the ultraviolet, visible, and infrared parts of the spectrum, including NIR. The term radiation refers to electromagnetic radiation in any portion of the spectrum, including, but not limited to ultraviolet, visible, and infrared light.

The disclosed device can be made by arranging series of at least one infrared and/or light emitting diodes (LED) in an art-known manner. These diodes emit infrared radiation dependent on a drive circuit which dictates the emitting pattern. Drive circuit means at least one element which is connected between the source of the power supply and the infrared or light-emitting diode. The circuit will orient NIR in a manner that gives the emitted radiation a twisting or rotating movement. The circuit can be similar to one shown in FIG. 1. The circuit will dictate such a pattern electronically or it can be made in such a manner that it will contain a mechanically rotating device such as a rotor. Alternatively the LED itself can be rotated at a speed that provides optimal spin and desired effect on photochemical reaction. The means of providing necessary angular speed and rotation methods desired for this invention are well known in the art and are described in detail in U.S. Pat. Nos. 4,163,281; 4,200,068; 4,491,424; 5,173,696; 5,440,879; 6,761,148; 6,830,015; and 7,066,753; provided herein by way of reference. In general such methods are the underlying principles of basic spin-generators such as oscillators as described in U.S. Pat. Nos. 6,775,054; 6,772,547; 7,230,637; 7,236,060; 7,236,059; 7,230,502; and 7,227,421, as non-limiting examples.

Physical Function

Like a normal diode, an LED consists of a chip of semiconducting material impregnated, or doped, with impurities to create a p-n junction. As in other diodes, current flows easily from the p-side, or anode, to the n-side, or cathode, but not in the reverse direction. Charge-carriers—electrons and electron holes—flow into the junction from electrodes with different voltages. When an electron meets a hole, it falls into a lower energy level, and releases energy in the form of a photon.

The wavelength of the light emitted, and therefore its color, depends on the band gap energy of the materials forming the p-n junction. In silicon or germanium diodes, the electrons and holes recombine by a non-radiative transition which produces no optical emission, because these are indirect bandgap materials. The materials used for an LED have a direct band gap with energies corresponding to infrared, near infrared, visible or near-ultraviolet light.

Conventional LEDs are made from a variety of inorganic semiconductor materials, producing the following colors: aluminum gallium arsenide (AlGaAs)—red and infrared; aluminum gallium phosphide (AlGaP)—green; aluminum gallium indium phosphide (AlGaInP)—high-brightness orange-red, orange, yellow, and green; gallium arsenide phosphide (GaAsP)—red, orange-red, orange, and yellow; gallium phosphide (GaP)—red, yellow and green; gallium nitride (GaN)—green, pure green (or emerald green), and blue also white (if it has an AlGaN Quantum Barrier); indium gallium nitride (InGaN)—near ultraviolet, bluish-green and blue; silicon carbide (SiC) as substrate—blue; silicon (Si) as substrate—blue; sapphire (Al₂O₃) as substrate—blue; zinc selenide (ZnSe)—blue; diamond (C)—ultraviolet; aluminum nitride (AlN), aluminum gallium nitride (AlGaN)—near to far ultraviolet (down to 210 nm).

One of the key advantages of LED-based lighting is its high efficiency, as measured by its light output per unit power input. It should be noted that high-power (≧1 Watt) LEDs are necessary for practical general lighting applications. A 5-watt LED produces 18-22 lumens per watt. For comparison, a conventional 60-100 watt incandescent light bulb produces around 15 lumens/watt (lm/W).

Today, organic LEDs (OLEDs) operate at substantially lower efficiency than inorganic (crystalline) LEDs. The best efficacy of an OLED so far is about 10% of the theoretical maximum of 683, so about 68 lm/W. OLEDs are claimed to be much cheaper to fabricate than inorganic LEDs, and large arrays of them can be deposited on a screen using simple printing methods to create a color graphic display.

Because the voltage versus current characteristics of an LED are much like any diode (that is, current is approximately an exponential function of voltage), a small voltage change results in a huge change in current. Added to deviations in the process, this means that a voltage source which may barely be sufficient to make one LED produce light may take another of the same type beyond its maximum ratings and potentially destroy it.

Since the voltage is logarithmically related to the current, it can be considered to remain largely constant over the LED's operating range. Thus the power can be considered to be almost proportional to the current. In order to keep power nearly constant with variations in supply and LED characteristics, the power supply should be a “current source”, that is, it should supply an almost constant current. If high efficiency is not required (e.g. in most indicator applications), an approximation to a current source can be made by connecting the LED in series with a current limiting resistor to a constant voltage source.

Provided there is sufficient voltage available, multiple LEDs can be connected in series with a single current limiting resistor. Parallel operation is generally problematic but can be overcome by art-known methods. Examples of voltage are as follows: Infrared 1.6 V; Red 1.8 V to 2.1 V; Orange 2.2 V; Yellow 2.4 V; Green 2.6 V; Blue 3.0 V to 3.5 V; White 3.0 V to 3.5 V; Ultraviolet 3.5 V.

LEDs produce more light per watt than do incandescent bulbs; this is useful in battery powered or energy-saving devices. LEDs can emit light of an intended color without the use of color filters that traditional lighting methods require. This is more efficient and can reduce initial costs. The solid package of an LED can be designed to focus its light. Incandescent and fluorescent sources often require an external reflector to collect light and direct it in a usable manner.

LEDs have an extremely long life span. One manufacturer has calculated the ETTF (Estimated Time To Failure) for their LEDs to be between 100,000 and 1,000,000 hours. Fluorescent tubes typically are rated at about 10,000 hours, and incandescent light bulbs at 1,000-2,000 hours.

LEDs are currently more expensive, price per lumen, on an initial capital cost basis, than more conventional lighting technologies. The additional expense partially stems from the relatively low lumen output and the drive circuitry and power supplies needed. However, when considering the total cost of ownership (including energy and maintenance costs), LEDs far surpass incandescent or halogen sources and begin to threaten compact fluorescent lamps.

The photoreaction, in particular photosynthesis, takes place in plants and algae which are characterized by naturally occurring chlorophyll-containing compounds or carotenoid-containing compounds. Other compounds in addition to chlorophyll and carotenoid that are susceptible to light and can be modulated by light include phycobilin compounds, phycobilisomes, phycobiliproteins, hydrazine, indigo and thioindigo derivatives, stilbene derivatives, modified aromatic olefins, cyanine-type dyes, indocyanine green, methylene blue, rose Bengal, Vitamin C, Vitamin E, Vitamin D, Vitamin A, Vitamin K, Vitamin F, Retin A, Adapalene, Retinol, Hydroquinone, Kojic acid, a growth factor, echinacea, an antibiotic, an antifungal, an antiviral, a bleaching agent, an alpha hydroxy acid, a beta hydroxy acid, salicylic acid, antioxidant, a seaweed derivative, a salt water derivative, algae, an antioxidant, a phytoanthocyanin, a phytonutrient, plankton, a botanical product, a herbaceous product, a hormone, an enzyme, a mineral, a cofactor, an anti-aging substance, insulin, minoxidil, lycopene, a natural or synthetic melanin, a metalloproteinase inhibitor, proline, hydroxyproline, an anesthetic, bacteriochlorophyll, copper chlorophyllin, chloroplasts, carotenoids, rhodopsin, anthocyanin, inhibitors of ornithine decarboxylase, inhibitors of vascular endothelial growth factor (VEGF), inhibitors of phospholipase A2, inhibitors of S-adenosylmethionine, licorice, licochalone A, genestein, soy isoflavones, phtyoestrogens, and derivatives, analogs, homologs, and subcomponents thereof and and combinations thereof are subjects of this disclosure without any limitation.

A particular embodiment of this invention is to use the instant emitter for more efficiently transforming solar energy by conventional solar batteries and/or thermal collectors. The photochemical compounds that are used in this process are well known in the art and are described for example in U.S. Pat. Nos. 5,816,238; 5,663,543; 5,647,343; 4,606,326; 4,565,799; 4,424,805; 4,394,858; 4,169,499; 4,105,014; 4,004,572 as incorporated herein by way of reference.

Light sources other than LEDs are capable of delivering the desired light at the desired wavelengths. Accordingly another embodiment of the disclosure is use of a light source and an interference filter such as a monochromator that can provide NIR in a desired range, instead of an LED. Yet another embodiment of the disclosure is an infrared laser which can replace an incandescent light bulb or LED and a narrow-band interference filter. Filters can be of other construction such as described in U.S. Pat. No. 4,108,373 which consists of an aqueous solution of copper chloride in water. Other infrared filters can be deployed such as a transparent polymer consisting of low density polyethylene, ethylenevinylacetate copolymer, polytetrafluoroethylene, polyvinylidenechloride, polyvinyl chloride, polycarbonate, polymethacrylate or mixtures thereof as described in U.S. Pat. No. 6,441,059. Other sources of infrared can be equally employed such as for example one described in U.S. Pat. No. 4,803,370. Alternatively, semiconductor nanocrystals having PbSe, PbS, InAs, or InSb core and emitting light in the near infrared spectral range, as described in U.S. Pat. No. 7,200,318, can be equally used as a source of radiation. Thus in addition to light emitting diode other sources of light or optical elements are equally useful including a laser, a fluorescent light source, an organic light emitting diode, a light emitting polymer, a xenon arc lamp, a metal halide lamp, a filamentous light source, a sulfur lamp, a photocatalytic discharge tube, and combinations thereof. Irradiation can be in form of pulsed light and/or a constant light stream.

It is also an aspect of this disclosure to provide an infrared emitter useful for designing novel information-recording devices, thermal (infrared) vision, optical scanners such as used for verifying the authenticity of bank notes, optical mouse or tracker, microarray chips, display sensors and protective spectacles that could be more advantageous than those designed for traditional non-rotating infrared emitters. For example microarray technology has been widely utilized in clinical diagnostics, disease mechanism research, drug discovery, environmental monitoring, functional genomics research etc. Biological probes, such as oligonucleotides, DNA, RNA, peptides, proteins, cells, and tissues, are immobilized on the surface of various substrate such as glass, silicon, nylon membrane and other suitable substrates. The detection of such probes is improved if emitters and sensors are enhanced by the present disclosure.

Another embodiment of this invention is to enhance chemical and physical processes other than photochemical reactions. It is clear that the types and kinds of chemical reactions amenable to the instant disclosure are almost unlimited. Examples of reactions that are encompassed by instant invention are for example heating, cooling, agitation, boiling, frying, steaming, dispersion, change of state including solution and emulsification, petroleum refinery, oxidation, reduction, blending, neutralization, change of shape, of density, of molecular weight, of viscosity or of pH. Other non-limiting examples that are more specifically chemical reactions are halogenation, nitration, reduction, cyanation, hydrolysis, catalysis, dehydroxation, epoxidation, ozonation diazotisation, alkylation, esterification, condensation, Mannich and Friedel-Crafts reactions and polymerization.

### EXAMPLE 1

Photosynthesis Enhancement by Infrared

A green plant is placed in hermetically sealed chamber fitted with CO₂ and O₂ sensors. After approximately 30 minutes the plant consumes most of available CO₂ and converts it to oxygen. An infrared emitter is switched on when absorption of CO₂ reaches a plateau. After approximately 5-10 minutes the plant starts consuming remaining CO₂. The sensors, which work in continuous mode, show that compared to plateau level there is between approximately a 25% and 33% reduction in CO₂ concentration.

### EXAMPLE 2

Photosynthesis Enhancement by Spinning Light Other than Infrared

A green plant is placed in a hermetically sealed chamber fitted with CO₂ and O₂ sensors. After approximately 30 minutes the plant consumes most of available CO₂ and converts it to oxygen. The light emitter is constructed in which infrared LEDs are replaced by LEDs having a different emission spectrum of light, in this instance white LEDs. This type of emitter is then directed on the plant when absorption of CO₂ reaches a plateau. After approximately 5-10 minutes the plant starts consuming the remaining CO₂. The sensors, which work in continuous mode, show that compared to plateau level there is approximately between 5% and 20% reduction in CO₂ concentration.

Other LEDs such aluminum gallium arsenide (AlGaAs)—red and infrared; aluminum gallium phosphide (AlGaP)—green; aluminum gallium indium phosphide (AlGaInP)—high-brightness orange-red, orange, yellow, and green; gallium arsenide phosphide (GaAsP)—red, orange-red, orange, and yellow; gallium phosphide (GaP)—red, yellow and green; gallium nitride (GaN)—green, pure green (or emerald green), and blue also white (if it has an AlGaN Quantum Barrier); indium gallium nitride (InGaN)—near ultraviolet, bluish-green and blue; silicon carbide (SiC) as substrate—blue; silicon (Si) as substrate—blue; sapphire (Al₂O₃) as substrate—blue; zinc selenide (ZnSe)—blue; diamond (C)—ultraviolet; aluminum nitride (AlN), aluminum gallium nitride (AlGaN)—near to far ultraviolet (down to 210 nm) are well known in the art and can be used equally without compromising the photosynthesis outcome.

### EXAMPLE 3

Wrinkle Reduction

Another particularly advantageous treatment regimen of the present disclosure is illustrated by wrinkle reduction. Three treatments are administered over 12 weeks using a 1064 nm Nd:YAG laser light source or infrared with spinning characteristic. The facial area of each patient is treated with three sessions. As a result the target tissue of each patient exhibits a substantial increase in new collagen production, thereby reducing the visibility of wrinkles.

### EXAMPLE 5

Acne Reduction

A particularly advantageous treatment regimen of the present disclosure is illustrated by treating patients exhibiting acne and acne scarring. Nine treatments are administered over several weeks using a combination of either red (620 nm) or infrared (850 nm) LEDs. As a result each patient exhibits a substantial decrease in visible acne and acne scarring as well as a reduction in the presence of acne bacteria.

### EXAMPLE 6

Enhanced Transformation of Solar Energy

A conventional solar battery or thermal collector that works by transforming the sun's energy into electricity or heat is exposed additionally to the output of the disclosed apparatus for a predetermined period of time. This exposure contributes additional energy such that the total power required for working the apparatus is substantially lower than the total photochemical energy output of solar battery or thermal collector.

It is to be understood that the above-described arrangements are merely illustrative of the many possible specific embodiments which can be devised to represent application of the principles of the disclosure. Numerous and varied other arrangements can be devised in accordance with these principles by those skilled in the art without departing from the spirit and scope of the disclosure.

What is claimed is:

1. A light-emitting apparatus comprising an infrared-emitting element and a controlling device which spins the emitted light.

2. The light-emitting apparatus of claim 1, wherein the emitted light has an infrared spectrum ranging from about 700 nm to 300,000 nm.

3. The light-emitting apparatus of claim 2, wherein the spectrum of emitted light is near infrared.

4. The light-emitting apparatus of claim 1, wherein the controlling device spins emitted light electronically.

5. The light-emitting apparatus of claim 1, wherein the controlling device spins emitted light mechanically.

6. The light-emitting apparatus of claim 1, wherein the controlling device is connected between a power source and the infrared-emitting element.

7. The light-emitting apparatus of claim 1, wherein the infrared-emitting element is mounted on the controlling device, wherein said device spins.

8. The light-emitting apparatus of claim 1, wherein the infrared-emitting element and the controlling device are mounted on separate boards.

9. The light-emitting apparatus of claim 1, wherein the emitted light spins at least 240 rotations per second.

10. A method of accelerating a photosynthesis reaction by illuminating a place wherein said photosynthesis reaction is taking place by providing infrared radiation produced by at least one light-emitting apparatus comprising an infrared-emitting element and a controlling device which spins the emitted light.

11. An illuminating apparatus constructed by setting up a plurality of light-emitting apparatuses in a predetermined arrangement wherein at least one light-emitting apparatus comprises an infrared-emitting element and a controlling device which rotates the emitted light.

12. The illuminating apparatus of claim 11 wherein the controlling device rotates the light mechanically.

13. The illuminating apparatus of claim 10 wherein the controlling device rotates the light electronically.

14. An apparatus for transforming infrared radiation into spinning radiation in such a manner that said spinning radiation acquires additional energy.

15. An apparatus of claim 14, wherein the additional energy is such that it enhances a photochemical reaction by at least 5%.

16. An apparatus of claim 14, wherein a velocity of spinning momentum is sufficient to enhance the photochemical reaction by at least 5%.
